(19) United States
(12) Patent Application Publication
(10) Pub. No.: US 2025/0276265 A1
(43) Pub. Date: Sep. 4, 2025

(54) GAS FILTER SYSTEM

(71) Applicant: MANN+HUMMEL GmbH, Ludwigsburg (DE)

(72) Inventors: Pascal NEEF, Trossingen (DE); Christoph WITTMERS, Bietigheim-Bissingen (DE); Andreas WEBER, Freiberg (DE); Dennis STARK, Mauer (DE); Mario RIEGER, Ludwigsburg (DE); Markus HANSELMANN, Lauffen (DE); Peter PEKNY, Neuenmarkt (DE); Eva HALLBAUER, Himmelkron (DE); Daniel SCHMID, Sachsenheim (DE); Steffen GERLACH, Nufringen (DE); Friedrich KUPFER, Marklkofen (DE); Philipp HETTKAMP, Steinheim (DE); Johannes GRAD, Simbach (DE); Pedro Miguel PEREIRA MADEIRA, Bietigheim-Bissingen (DE); Dieter WEISS, Gefrees (DE)

(21) Appl. No.: 19/083,504

(22) Filed: Mar. 19, 2025

Related U.S. Application Data
(63) Continuation of application No. PCT/EP2023/067124, filed on Jun. 23, 2023.

(30) Foreign Application Priority Data
Sep. 20, 2022 (DE) 102022124022.3

(51) Int. Cl. B01D 46/64; B01D 46/00; B01D 46/24; B01D 46/52; B60H 3/06; H01M 8/0662

(52) U.S. Cl. CPC B01D 46/64; B01D 46/0004; B01D 46/2414; B01D 46/521; B60H 3/0658; H01M 8/0687; B01D 2265/06; B01D 2267/30; B01D 2271/027; B01D 2279/60

(57) ABSTRACT

A gas filter system has an outer filter element with a first end plate, a second end plate, and a first filter medium arranged between the first and the second end plates. An inner filter element with a third end plate, a fourth end plate, and a second filter medium arranged between the third and the fourth end plates is provided. The first end plate and the third end plate each have an opening. The first end plate surrounds the third end plate. The first end plate has a first seal protrusion protruding in an axial direction of the gas filter system. The third end plate has a second seal protrusion protruding in the axial direction of the gas filter system. For sealing the third end plate and the first end plate relative to each other, the first seal protrusion and the second seal protrusion engage each other.

### CROSS-REFERENCE TO RELATED APPLICATIONS

This application is a continuation application of international application No. PCT/EP2023/067124 having an international filing date of Jun. 23, 2023, and designating the United States, the international application claiming a priority date of Sep. 20, 2022, based on prior filed German patent application No. 10 2022 124 022.3, the entire contents of the aforesaid international application and the aforesaid German patent application being incorporated herein by reference.

### BACKGROUND

The invention concerns a gas filter system with an outer filter element and an inner filter element which are sealed relative to each other. The invention concerns in addition the use of an outer filter element and/or an inner filter element in a gas filter system.

Such filter systems provide a high filtration degree and are used, for example, for filtering combustion air for internal combustion engines, for filtering cathode air of fuel cells but also as cabin air filters. For example, in the filtration of cathode air for fuel cells, filter elements with different properties are used, wherein a filter medium is configured for particle filtration and the other filter medium enables the adsorption of harmful gases such as nitrous oxides.

In order to enable a compact filtration system in spite of a plurality of filter elements, the filter elements are typically installed in a common housing, wherein possible leakage flows that cause bypassing of the filter elements must be reliably prevented. For this purpose, the filter elements are sealed often in relation to the housing, respectively, resulting in great demands in regard to a constructive configuration of the filter system. When the sealing actions are matched to each other only insufficiently, for example, due to unavoidable manufacturing tolerances, unfiltered gas may bypass the filter elements. This reduces the operational function of the filter system.

In order to prevent leakage flows, the filter elements are often glued to each other and/or to the housing. However, then the filter elements can be exchanged during servicing only in a complicated manner causing damage to the gas filter system.

DE 10 2018 215 603 A1 discloses a modular filter element with an outer filter element and an inner filter element which are sealed relative to each other. The inner filter element is arranged inside the outer filter element.

It is an object of the invention to improve the operational function of a gas filter system with respect to sealing of the filter elements in relation to each other.

### SUMMARY

This object is solved by a gas filter system including:
an outer filter element with a filter medium arranged between a first end plate and a second end plate;
an inner filter element with a second filter medium arranged between a third end plate and a fourth end plate;
wherein the first end plate and the third end plate are of an open configuration;
wherein the first end plate surrounds the third end plate;
wherein the first end plate includes a first seal protrusion protruding in axial direction;
wherein the third end plate includes a second seal protrusion protruding in axial direction; and
wherein, for sealing the third end plate and the first end plate relative to each other, the first seal protrusion and the second seal protrusion engage each other.

In addition, the object is solved by a use of an outer filter element and/or of an inner filter element in a gas filter system according to the invention.

Further embodiments are disclosed in the following description and shown in the accompanying drawing figures.

According to the invention, a gas filter system is provided. The gas filter system may be used, for example, for filtering combustion air for internal combustion engines or fuel cells but also as cabin air filters.

The gas filter system includes an outer filter element. The outer filter element includes a first filter medium arranged between a first end plate and a second end plate. In addition, the gas filter system includes an inner filter element. The inner filter element includes a second filter medium arranged between a third end plate and a fourth end plate.

The first filter medium and/or the second filter medium is fastened gas-tightly to the respective end plates, for example glued to the respective end plates or formed integrally at the respective filter medium. In other words, the end plates close and seal the respective filter medium, for example at its filter medium end faces in axial direction. In this way, leakage flows within the respective filter element can be prevented.

The first and/or the second filter medium, for example the outer and/or the inner filter medium, may surround annularly a longitudinal axis of the gas filter system. The filter media may be arranged concentrically relative to each other and to the longitudinal axis. The respective filter medium may be folded in a star shape, for example, or wound. The filter medium may be round or oval in cross section. The filter medium may be cylindrical or conical in axial direction. Directional indications such as, for example, axial or radial, relate here and in the following to the longitudinal axis of the gas filter system, if nothing to the contrary is indicated. The longitudinal axes of the two filter elements may coincide, but may also deviate from each other. For example, the longitudinal axis of the inner filter element could be at a slant to the longitudinal axis of the outer filter element, for example, in case the inner filter element is embodied conically and the outer filter element cylindrically and the end plate of the inner filter element facing away from the gas inlet or the gas outlet is not arranged about the center of the gas filter system.

The first end plate and the third end plate are of an open configuration. The opening of the third end plate enables entry or exit of gas into or out of an interior of the filter element. Furthermore, the opening of the first end plate may serve for arranging the inner filter element in the outer filter element.

The first end plate surrounds the third end plate at the circumference. In other words, the third end plate is at least partially, or alternatively completely, arranged inside of the first end plate. Furthermore, the inner filter element may be arranged at least primarily, or alternatively completely, inside of the outer filter element. In this way, compact dimensions of the gas filter system may be obtained.

The first end plate includes, for example at a side which is facing away from the first filter medium, a first seal protrusion protruding in axial direction. The third end plate includes, for example at a side facing away from the second filter medium, a second seal protrusion protruding in axial direction. In other words, the seal protrusions protrude along the longitudinal axis of the gas filter system past the respective end plate. The first and the second seal protrusions protrude in the same direction along the longitudinal axis past the respective end plate. The seal protrusions serve for seal-tight contact at a corresponding counter contour, for example, the respective other seal protrusion and/or the housing of the gas filter system. The seal protrusions may be integrally formed at the respective end plates.

As an alternative, the seal protrusions and the end plates covering the axial end faces of the filter medium bodies may be components which are separate from each other and which are connected to be each other, for example, by gluing, fusing or injection molding. These multi-part embodiments are also encompassed by the term end plates.

The seal protrusions each may have at least one section which extends additionally in a radial direction, for example in a radial direction past the respective end plate. In principle, the first and the second seal protrusions include different cross sections. For example, the seal protrusions may be configured to be complementary to each other in order to enable a form fit engagement with each other. The first seal protrusion or the second seal protrusion may include, for example, a groove-shaped (U-shaped) cross section, while the respective other seal protrusion may include a web-shaped (I-shaped) cross section.

The third end plate and the first end plate are sealed in relation to each other. In other words, leakage flows between the first end plate and the third end plate are prevented bidirectionally. For this purpose, the first seal protrusion and the second seal protrusion engage each other.

Due to an embodiment of the gas filter system according to the invention, for example due to an interaction of the seal protrusions of both filter elements, its seal tightness may be improved in an advantageous manner. Leakage flows may thus be reliably prevented and a simple exchange of the filter elements may be ensured at the same time so that the operational function of the gas filter system may be enhanced.

In an embodiment of the gas filter system, the first seal protrusion and the second seal protrusion rest seal-tightly against each other at least at two protrusion seal surfaces. The protrusion seal surfaces may be spaced apart from each other with respect to their location. For example, the protrusion seal surfaces may have a different orientation. In this way, leakage paths may be even more effectively prevented, whereby the sealing action may be further improved.

In a further embodiment, a first seal protrusion and a second seal protrusion rest seal-tightly against each other at least one axial protrusion seal surface and at least one radial protrusion seal surface. The axial protrusion seal surface and the radial protrusion seal surface may adjoin each other. In this way, the seal region may be designed to be particularly compact.

In another embodiment of the gas filter system, one of the seal protrusions is elastically configured and engages around the other seal protrusion so that it is widened by the engagement of the other one of the seal protrusions. The elastic seal protrusion may include polyurethane; for example, the elastic seal protrusion is embodied of polyurethane. The other seal protrusion may be stiff, for example embodied of polypropylene.

In another embodiment of the gas filter system, the first seal protrusion and/or the second seal protrusion is designed so as to extend circumferentially at the respective end plate. For example, the first and the second seal protrusion are configured to extend circumferentially. In other words, the first seal protrusion and/or the second seal protrusion may be of an annular closed configuration around the longitudinal axis. In this way, the sealing action may be further improved.

For a reliable function of the gas filter system, it may be required that only filter elements matching the specifications are used. In addition, for additional functions, for example, an air flow meter, the rotatory installation position of a filter element having principally rotational symmetry may be important because same-type filter elements, due to manufacture, may have same-type deviations from an ideal. For example, air flow meters react very sensitively to such deviations; therefore, when these deviations always occur in the same manner, they may be compensated.

In a further embodiment, the first seal protrusion and the second seal protrusion each include at least one radial recess and/or one radial protrusion. The corresponding seal protrusion, when viewed in the direction of the longitudinal axis, is thus not precisely embodied in a basic, for example, circular, shape but includes deviations from the basic shape, for example, the circular shape. The at least one radial recess or protrusion may participate in the sealing action in relation to the respective other seal protrusion and/or a housing. The respective other seal protrusion and/or the housing may be embodied correspondingly. Thus, a radial protrusion at one seal protrusion engages a radial recess at the other seal protrusion. Due to the deviation from the basic, for example circular, shape at the seal protrusion, an installation of the filter element in a defined rotational orientation is enforced. In addition, it is ensured that only filter elements which are matched to the respective gas filter system can be used.

In a further embodiment of the gas filter system, the first seal protrusion and/or the second seal protrusion includes at least one housing seal surface for seal-tight contact at a housing, for example in an axial direction. The first seal protrusion and/or the second seal protrusion may include the at least one housing seal surface at a side facing away from the side which is in engagement with the other seal protrusion. The corresponding seal protrusion may thus be arranged between the housing and the respective other seal protrusion and is beneficial to a simultaneous sealing action of two possible leakage paths.

In another embodiment, the gas filter system includes a closed bottom plate. For example, the bottom plate is arranged at the second end plate of the outer filter element. For example, the bottom plate is of a gas-tight configuration. In other words, the bottom plate may seal the first filter medium at the second end plate in axial direction. By means of a closed bottom plate, a flow bypassing the outer filter element may be prevented.

In a further embodiment of the gas filter system, the bottom plate includes a support structure, for example at least one support rib projecting in axial direction, for supporting the fourth end plate of the inner filter element. In other words, the outer filter element forms a stop surface for the inner filter element. In this way, positioning of the inner filter element within the outer filter element may be realized true to position. This enhances the seal-tight engagement of the seal protrusions in each other.

In another embodiment of the gas filter system, the outer filter element includes radially inwardly a support pipe. In other words, the filter medium may be stabilized radially inwardly by a support pipe. The bottom plate may be formed integrally together with the support pipe.

As an alternative or in addition, the filter medium may be stabilized radially outwardly by a cage. For outward stabilization, for example of a wound filter element, also a thread winding may be attached at the filter element. In this way, the filter element may be designed more stiffly so that dynamically caused leakage paths due to length changes of the filter element during operation may be prevented.

In another embodiment of the gas filter system, the outer filter element and the inner filter element are of a hollow-cylindrical configuration. Due to a hollow-cylindrical configuration, a high inflow surface may be obtained simultaneously with compact dimensions for each individual filter element as well as the entire gas filter system.

In a further embodiment of the gas filter system, it is provided that the outer filter element is connected upstream of the inner filter element in a flow direction of the gas filter system. In other words, the outer filter element and the inner filter element are connected in series such that the gas filter system is flowed through radially inwardly. In this way, reduced pressure differences between the inflow side and the outflow side of the filter elements result, whereby the formation of leakage flows may be prevented.

One of the filter media is configured for particle filtration and is comprised of or comprises cellulose, while the other filter medium is configured for harmful gas adsorption and is comprised of or comprises, for example active carbon for this purpose. The filter element for particle filtration is arranged in flow direction upstream of the filter element for harmful gas adsorption.

In another embodiment of the gas filter system, the latter includes an openable housing. The housing typically includes a first housing part and a second housing part, for example, a housing pot and a removable housing cover. The outer filter element and the inner filter element are for example arranged between the first housing part and the second housing part. In other words, the inner and the outer filter elements may be received in the housing. The housing includes for example at least one inlet opening for inflow of gas into the gas filter system and at least one outflow opening for outflow of gas out of the gas filter system. The inlet opening may be for example arranged directly upstream of the outer filter element. The outlet opening may be for example arranged directly downstream of the inner filter element. The first housing part includes for example an end face facing the first and the third end plates of the filter elements. The end face may include a housing seal groove which corresponds to the first seal protrusion and/or the second seal protrusion and in which the first seal protrusion and the second seal protrusion are arranged engaging each other. In this way, a raw gas side of the gas filter system may be effectively sealed in relation to a clean gas side of the gas filter system. In other words, the at least one inlet opening may be in fluid communication with the at least one outlet opening only through the inner and the outer filter elements.

In another embodiment of the gas filter system, the end face includes an opening which is arranged in fluid communication upstream or downstream of the inner filter element. In other words, the inlet opening or the outlet opening may be formed at the end face of the housing.

In another embodiment of the gas filter system, the first housing part includes a central pipe at the end face which engages in the inner filter element. The central pipe may be designed for supporting the second filter medium. For example, the central pipe is configured in a lattice shape. The central pipe may extend along the longitudinal axis at least across a third, for example across at least two thirds, across the entire dimension of the inner filter element in the length direction. In this way, an effective support of the second filter medium may be realized.

In another embodiment of the gas filter system, the housing includes a closure arranged at the circumference, wherein the closure in a closed state effects a gas-tight clamping of the first housing part and of the second housing part with the outer filter element and the inner filter element. In other words, the housing, in a closed state, may include dimensions in the length direction which are below the dimensions of the filter elements nested in each other in the length direction. In this way, the filter elements or the seal protrusions may be compressed slightly upon closing of the housing, whereby a sufficient gas-tight contact of the seal protrusions at each other and/or at the housing is effected.

The scope of the invention also encompasses a use of an outer filter element and/or of an inner filter element in a gas filter system according to the invention as described above and in the following. The outer filter element or the inner filter element may include features described above and in the following.

Furthermore, the scope of the invention encompasses a filter element with the corresponding features. The filter element includes a filter medium arranged between two end plates. One end plate includes a first seal protrusion protruding in axial direction. The first seal protrusion includes at least one protrusion seal surface. The protrusion seal surface is configured to contact seal-tightly a further protrusion seal surface of an axially protruding second seal protrusion of an end plate of a further filter element. In an embodiment, the first seal protrusion is manufactured of a soft material, for example foamed polyurethane, and for example configured as one piece together with the end plate. The first seal protrusion may be arranged at the inner circumference of the end plate and may have the shape of a U which is oriented in axial direction toward the open interior of the filter element. The free leg of the U is radially inwardly arranged. In this way, a receiving groove is formed. In this manner, a rigid rib-shaped seal protrusion of a second filter element arranged in this filter element may engage the seal protrusion so that the two filter elements are sealed relative to each other. In an alternative embodiment, the filter element with the soft seal protrusion including a groove forms the inner filter element and the filter element with the rigid rib-shaped seal protrusion the outer filter element. In this case, the U-shaped groove is arranged at the outer circumference of the end plate and the free leg is arranged radially outwardly.

### BRIEF DESCRIPTION OF DRAWINGS

Further features and advantages of the invention result from the following detailed description of exemplary embodiments of the invention with the aid of the accompanying drawing figures showing or illustrating details according to the invention. The aforementioned and still to be explained features may be realized individually by themselves or several combined in arbitrary expedient combinations in variants of the invention. The features shown in the drawings are illustrated such that the particularities according to the invention may be made clearly visible.

FIG. 1 shows a first embodiment of a gas filter system according to the invention with an outer filter element and an inner filter element, comprising a first end plate and a third end plate, respectively, whose seal protrusions engage each other seal-tightly, in a schematic section view.

FIG. 2 shows a detail of the gas filter system of FIG. 1 in a schematic section view.

FIG. 3 shows the outer filter element of the gas filter system of FIGS. 1 and 2 in a schematic perspective view.

FIG. 4 shows the inner filter element of the gas filter system of FIGS. 1 and 2 in a schematic perspective view.

FIG. 5 shows a second embodiment of a gas filter system according to the invention in a schematic section view.

FIG. 6 shows a detail of the gas filter system of FIG. 5 in a schematic section view.

FIG. 7 shows the outer filter element of the gas filter system of FIGS. 5 and 6 in a schematic perspective view.

FIG. 8 shows the inner filter element of the gas filter system of FIGS. 5 and 6 in a schematic perspective view.

### DETAILED DESCRIPTION

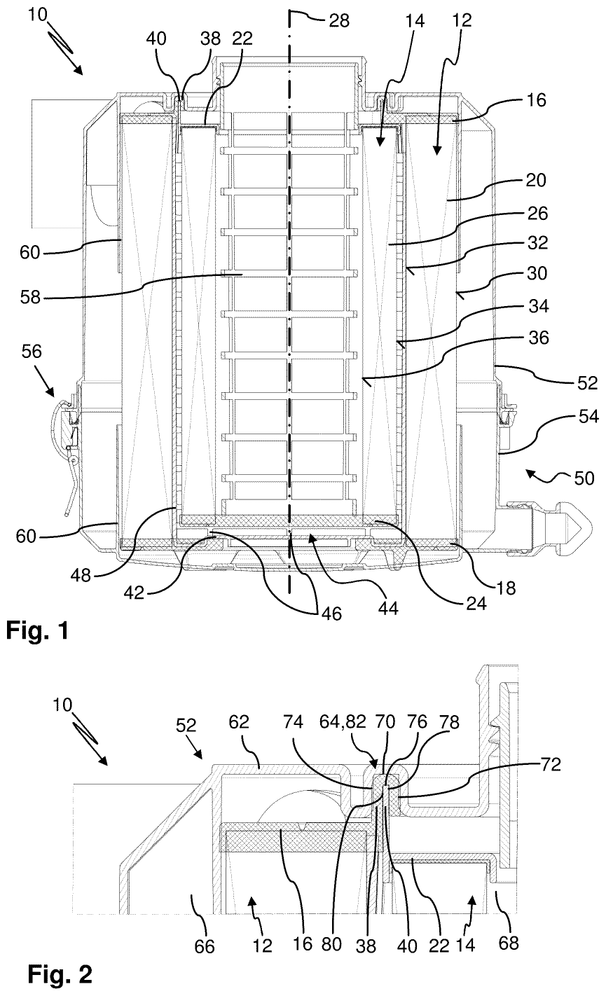

FIG. 1 shows a first embodiment of a gas filter system 10 with an outer filter element 12 and an inner filter element 14.

The outer filter element 12 comprises a first filter medium 20 arranged between a first end plate 16 and a second end plate 18. The first filter medium 20 is fastened gas-tightly to the end plates 16, 18. The end plates 16, 18 are for example injection-molded to the first filter medium 20.

The inner filter element 14 comprises a second filter medium 26 arranged between a third end plate 22 and a fourth end plate 24. The second filter medium 26 is likewise fastened gas-tightly to the end plates 22, 24. The end plates 22, 24 are for example injection-molded to the first filter medium 26.

The first and/or second filter medium 20, 26 is/are designed for filtering gas flowing through the filter media 20, 26. The first and/or second filter medium 20, 26 is formed of a folded or pleated filter material. In this way, the inflow surface area of the filter elements 12, 14 may be enlarged, which has a beneficial effect on the pressure loss. One of the filter materials comprises active carbon for adsorption of harmful gases.

According to the illustrated embodiment, the outer filter element 12 and the inner filter element 14 may be configured hollow-cylindrically about a longitudinal axis 28. Typically, the inner filter element 14 is arranged inside the outer filter element 12. In this case, the filter elements 12, 14 are typically flowed through in a radial direction, for example radially inwardly. The outer filter element 12 may form a radially outer inflow side 30 and a radially inner outflow side 32. The inner filter element 14 may form a radially outer inflow side 34 and a radially inner outflow side 36.

In a typical operation of the gas filter system 10, a gas, not illustrated in detail, flows first against the outer filter element 12 at the inflow side 30, is guided through the first filter medium 20 and is subsequently discharged via the outflow side 32. Subsequently, the gas pre-filtered by the first filter medium is guided via the inflow side 34 through the second filter medium 26 and discharged via the outflow side 36 of the second filter medium 26. In other words, the gas filter system 10 may be radially flowed through. The first filter medium 20 and the second filter medium 26 are connected in series with respect to fluid flow.

The outer filter element 12 surrounds the inner filter element 14 at the circumference. In other words, the first filter medium 12 covers completely the inflow side 34 of the second filter medium 26. In this way, pressure losses may be kept as small as possible.

As illustrated here in an exemplary fashion, the first filter element 12 and the second filter element 14 may be coaxially arranged relative to each other. For example, the first and the second filter elements 12, 14 are coaxially arranged in relation to the longitudinal axis 28.

The first end plate 16 comprises a first seal protrusion 38 protruding in an axial direction or along the longitudinal axis 28 past the first end plate 16. The third end plate 22 comprises a second seal protrusion 40 protruding in an axial direction or along the longitudinal axis 28 past the third end plate 22. The first seal protrusion 38 and/or the second seal protrusion 40 each may be arranged at the side of the end plate 16, 22 which is positioned opposite the respective filter medium 20, 26 of the same filter element 12, 14. For example, the first and/or the second seal protrusion 38, 40 is formed as one piece together with the respective end plate 16, 22.

The first seal protrusion 38 and the second seal protrusion 40 engage each other in order to gas-tightly seal the filter elements 12, 14, which are arranged adjacent to each other, at the end plates 16, 22.

According to the illustrated embodiment, the outer filter element 12 may comprise a bottom plate 42. The bottom plate 42 may comprise a support structure 44, here in the form of several support ribs 46. The support structure 44 is designed for supporting the fourth end plate 24 of the inner filter element 14.

Furthermore, the outer filter element 12 may comprise a support pipe 48. The support pipe 42 may be configured for supporting the first filter medium 20 in relation to a pressure force caused by flow. The support pipe 48 is for example of a lattice-type configuration so that the flow resistance may be kept minimal.

The bottom plate 42 and/or the support pipe 48 is arranged at the second end plate 18, for example partially embedded therein. In this way, the outer filter element 12 may be configured as a particularly gas-tight unit.

The support pipe 48 is formed as one piece together with the bottom plate 42. In this way, the number of individual parts may be kept low so that assembly of the gas filter system 10 may be simplified.

In an alternative embodiment, not illustrated, the outer filter element 12 has no bottom plate. The annular end plate 18 surrounds then an opening to the interior of the filter element 12. This makes it possible to mount first the outer filter element 12 and then push the inner filter element 14 through the opening in the bottom of the outer filter element 12. In this way, the flexible first seal protrusion 38 may be positioned in the housing seal groove provided for this—to be explained hereafter—and then the rib-type second seal protrusion 40 may be safely inserted into the first seal protrusion 38.

The gas filter system 10 may comprise a housing 50 with a first housing part 52 and a second housing part 54. The first housing part 52, for example by means of a closure 56, may be detachably arranged at the second housing part 54. In accordance with the illustrated embodiment, the closure 56 may be designed as a clamp closure in order to push gas-tightly the filter elements 12, 14, arranged between the first housing part 52 and the second housing part 54, against the housing parts 52, 54 in a closed state of the housing 50.

As illustrated in FIG. 1, the gas filter system 10 may comprise a central pipe 58. The central pipe 58 may be arranged at the first housing part 52. For example, the central pipe 58 is fastened to the first housing part 52. The central pipe 58 may extend at least across a portion of the axial extension, for example across the entire axial extension, of the second filter medium 26. In this way, the second filter medium 26 may be supported in radial direction, for example, in case of flow-caused force action.

In an embodiment, the housing 50 may comprise at least a filter element receptacle 60. For example, the housing 50 may comprise a filter element receptacle 60 at the first housing part 52 and at the second housing part 54, respectively. The filter element receptacle 60 may be configured as a radially inwardly recessed wall which engages the outer filter element 12 at its radial outer side. In this way, the filter elements 12, 14 of the gas filter system 10 may be pre-positioned and the assembly can be simplified.

FIG. 2 shows a detail of the gas filter system 10 of FIG. 1 in a detail view.

The first housing part 52 comprises an end face 62 which is facing the outer filter element 12 and the inner filter element 14, respectively, the first end plate 16 and the third end plate 22. The end face 62 forms a housing seal groove 64. The second seal protrusion 40 and the first seal protrusion 38, which is in engagement with the second seal protrusion 40, are arranged in the housing seal groove 64. In this way, a raw gas side 66 of the gas filter system 10 may be sealed in relation to a clean gas side 68 of the gas filter system 10.

The first seal protrusion 38 may comprise an elastic material, for example PUR. The first seal protrusion 38, as illustrated, is formed of the elastic material. The second seal protrusion 40 may comprise a stiff material, for example polyamide or polypropylene. The second seal protrusion 40, as illustrated, is formed of the stiff material.

According to the illustrated embodiment, the first seal protrusion 38 may contact the housing seal groove 64 by means of an axial housing seal surface 70, a radially inner housing seal surface 72 as well as a radially outer housing seal surface 74. In this way, a particularly high sealing action may be achieved.

Further according to the illustrated embodiment, the first seal protrusion 38 and the second seal protrusion 40 may engage each other such that the first seal protrusion 38 surrounds the second seal protrusion 40. In other words, the first seal protrusion 38 may contact the second seal protrusion 40 at least at an axial protrusion seal surface 76, a radially inner protrusion seal surface 78 as well as a radially outer protrusion seal surface 80.

When assembling the gas filter system 10, pushing of the first seal protrusion 38 against the end face 62 or against the housing seal groove 64 may be realized by the second seal protrusion 40 in the illustrated embodiment. A sealing action of the raw gas side 66 in relation to the clean gas side 68 when using two filter elements 12, 14 may be realized in this way particularly easily in a single seal region 82. The complex constructive configuration and precise manufacture of a respective separate seal region for each filter element 12, 14 is thus obsolete.

In an alternative embodiment, not illustrated, of the upper end face in the drawing, the outer filter element 12 comprises the stiff rib-type seal protrusion and the inner filter element 14 comprises the corresponding soft groove-type seal protrusion. In this way, the inner filter element 14 may be mounted first in the housing part 52 and the outer filter element 12 may be subsequently pushed on so that its seal protrusion protrudes into the seal protrusion of the inner filter element 14.

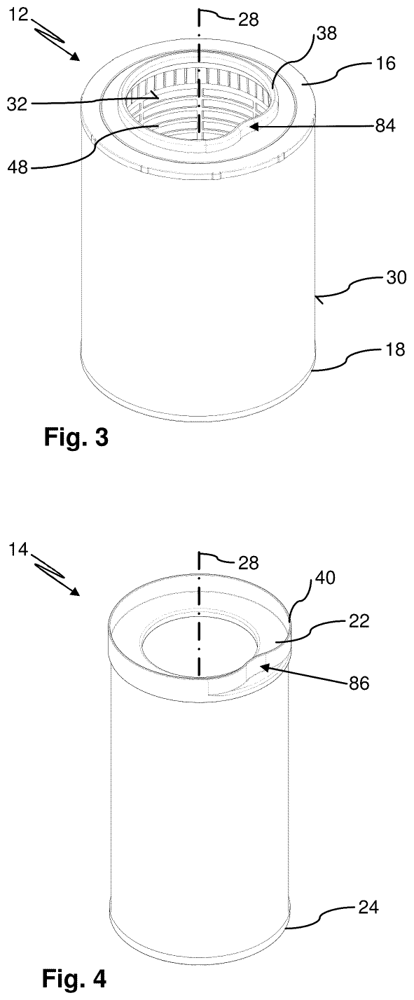

FIG. 3 shows the outer filter element 12 of the FIGS. 1 and 2 in a perspective view.

The first seal protrusion 38 is configured so as to extend circumferentially at the first end plate 16. According to the illustrated embodiment, the first seal protrusion 38 may comprise a radial recess 84. The radial recess 84 may be understood as a radially inwardly oriented deviation of the first seal protrusion 38 which is otherwise rotationally symmetrically configured. The recess 84 may enable a rotationally secured arrangement of the first filter element 12 at the housing 50 (see FIGS. 1, 2) so that a precise positioning may be ensured.

FIG. 4 shows the inner filter element 14 of the FIGS. 1, 2 in a perspective view.

The second seal protrusion 40 is configured so as to extend circumferentially at the third end disk 22. According to the illustrated embodiment, the second seal protrusion 40 may comprise a radial recess 86. The radial recess 86 is configured corresponding to the radial recess 84 of the outer filter element 12 (see FIG. 3).

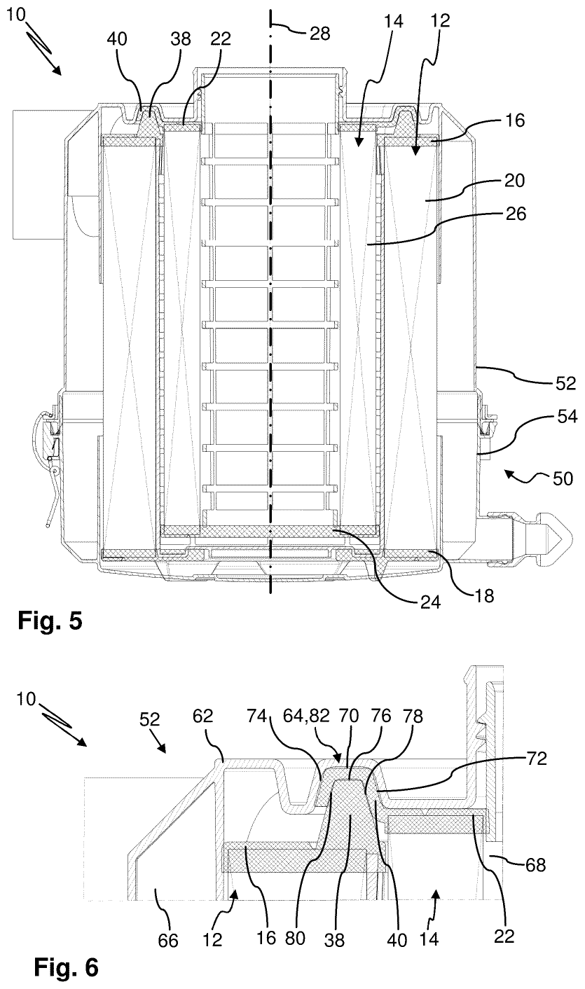

FIG. 5 shows a second embodiment of a gas filter system 10.

The illustrated second embodiment of the gas filter system 10 differs from the gas filter system 10 of FIG. 1 substantially in the configuration of the first end plate 16 and the third end plate 22. Aside from the deviations explained in the following, the second embodiment corresponds to the first embodiment; therefore, reference is being had to the above description.

According to the illustrated second embodiment, the first end plate 16 may form a first seal protrusion 38 and the third end plate 22 may form a second seal protrusion 40. The first seal protrusion 38 is in engagement with the second seal protrusion 40. According to the illustrated second embodiment, the second seal protrusion 40 may seal-tightly contact the housing 50, respectively, the first housing part 52. Furthermore, the second seal protrusion 40 of the inner filter element 14 may engage around the first seal protrusion 38 of the outer filter element 12.

FIG. 6 shows a detail of the second embodiment of the gas filter system 10 of FIG. 5 in a detail view.

The second seal protrusion 40 and the first seal protrusion 38 in engagement with the second seal protrusion 40 are arranged in the housing seal groove 64 which is formed at the end face 62 of the first housing part 52. The raw gas side 66 of the gas filter system 10 may thereby be sealed in relation to the clean gas side 68 of the gas filter system 10.

According to the second embodiment, the first seal protrusion 38 may comprise an elastic material, for example PUR, or may be embodied of the elastic material. The second seal protrusion 40 may also comprise an elastic material, for example PUR, or may be embodied of the elastic material. For example, one of the seal protrusions 38, 40 may be configured for widening the respective other seal protrusion 40, 38. Here, the first seal protrusion 38 in cross section is of a trapezoidal shape or a wedge shape so that, upon arranging the first seal protrusion 38 at or in the second seal protrusion 40, the latter is radially widened. In this way, pressing the second seal protrusion 40 against the housing seal groove 64 may be realized, which improves the sealing action. Furthermore, the contact force between the first seal protrusion 38 and the second seal protrusion 40 may be increased, which further improves the sealing action.

According to the second illustrated embodiment, when widening the second seal protrusion 40, the axial housing seal surface 70, the radially inner housing seal surface 72 as well as the radially outer housing seal surface 74 may be formed between the second seal protrusion 40 and the housing seal groove 64. Upon widening the second seal protrusion 40, the axial protrusion seal surface 76, the radially inner protrusion seal surface 78 as well as the radially outer protrusion seal surface 80 may form between the first seal protrusion 38 and the second seal protrusion 40.

In the second embodiment, sealing of the raw gas side 66 in relation to the clean gas side 68 when using two filter elements 12, 14 may thus also be realized particularly easily in a single seal region 82.

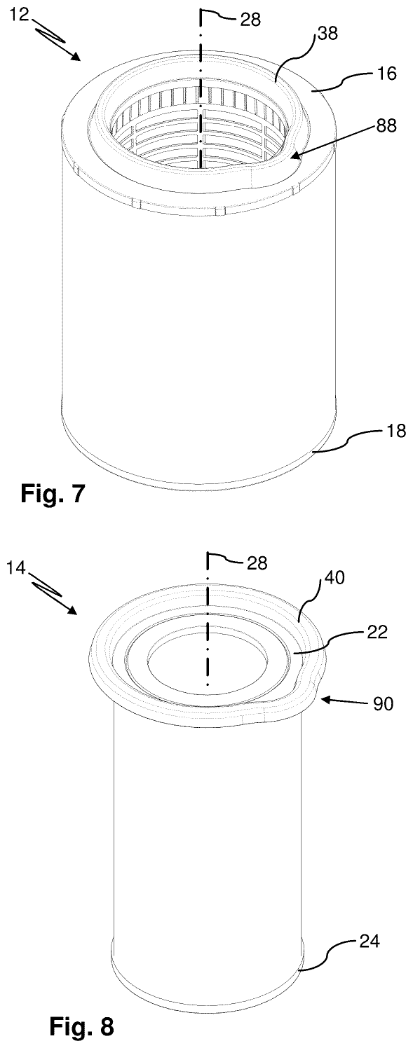

FIG. 7 shows the outer filter element 12 of the FIGS. 5 and 6 in a perspective view.

The outer filter element 12 according to the second embodiment of the gas filter system 10 of the FIGS. 5 and 6 comprises a radial protrusion 88 formed at the first seal protrusion 38. The radial protrusion 88 may be understood as a radially outwardly oriented deviation of the first seal protrusion 38 which is otherwise rotationally symmetrically configured. The protrusion 88 may enable of a rotationally secured arrangement of the first filter element 12 at the housing 50 (see FIGS. 5, 6) so that a precise positioning may be ensured.

FIG. 8 shows the inner filter element 14 of the FIGS. 5 and 6 in a perspective view.

The second seal protrusion 40 may comprise, as illustrated, a radial protrusion 90. The radial protrusion 90 is embodied so as to correspond to the radial protrusion 88 of the outer filter element 12 (see FIG. 7) so that also the position of the inner filter element 14 relative to the outer filter element 12 or to the housing 50 is fixed.

17. (canceled)

18. A gas filter system comprising:
an outer filter element with a first filter medium arranged between a first end plate and a second end plate;
an inner filter element with a second filter medium arranged between a third end plate and a fourth end plate;
wherein the first end plate and the third end plate are of an open configuration;
wherein the first end plate surrounds the third end plate;
wherein the first end plate comprises a first seal protrusion protruding in an axial direction;
wherein the third end plate comprises a second seal protrusion protruding in the axial direction; and
wherein, for sealing the third end plate and the first end plate relative to each other, the first seal protrusion and the second seal protrusion engage each other.

19. The gas filter system according to claim 18, wherein the first seal protrusion and the second seal protrusion seal-tightly contact each other on at least two protrusion seal surfaces.

20. The gas filter system according to claim 19, wherein the first seal protrusion and the second seal protrusion seal-tightly contact each other on at least one axial protrusion seal surface and at least one radial protrusion seal surface.

21. The gas filter system according to claim 18, wherein one of the first and second seal protrusions is elastically embodied and engages across the other one of the first and second seal protrusions so that the one of the first and second seal protrusions is widened by the engagement of the other one of the first and second seal protrusions.

22. The gas filter system according to claim 18, wherein the first seal protrusion and/or the second seal protrusion is/are embodied to extend circumferentially at the respective first end plate and/or third end plate.

23. The gas filter system according to claim 22, wherein the first seal protrusion and the second seal protrusion each comprise at least one radial recess and/or at least one radial protrusion.

24. The gas filter system according to claim 18, wherein the first seal protrusion and/or the second seal protrusion comprises at least one housing seal surface for seal-tightly contact at a housing.

25. The gas filter system according to claim 18, further comprising a bottom plate arranged at the second end plate of the outer filter element.

26. The gas filter system according to claim 25, wherein the bottom plate comprises a support structure projecting in the axial direction for supporting the fourth end plate of the inner filter element.

27. The gas filter system according to claim 18, wherein the outer filter element comprises a support pipe arranged radially inwardly in relation to the axial direction.

28. The gas filter system according to claim 18, wherein the outer filter element and the inner filter element are embodied hollow-cylindrically.

29. The gas filter system according to claim 18, wherein the outer filter element is connected upstream of the inner filter element in a flow direction of the gas filter system.

30. The gas filter system according to claim 18, further comprising an openable housing with a first housing part and a second housing part;
wherein the outer filter element and the inner filter element are arranged between the first housing part and the second housing part;
wherein the first housing part comprises an end face facing the first end plate and/or the third end plate of the outer filter element and the inner filter element;
wherein the end face comprises a housing seal groove corresponding to the first seal protrusion and/or the second seal protrusion;
wherein the first seal protrusion and the second seal protrusion are arranged engaging each other in the housing seal groove to seal a raw gas side of the gas filter system in relation to a clean gas side of the gas filter system.

31. The gas filter system according to claim 30, wherein the end face has an opening which is connected in fluid communication upstream or downstream of the inner filter element.

32. The gas filter system according to claim 30, wherein the first housing part comprises at the end face a central pipe which engages in the inner filter element.

33. The gas filter system according to claim 30, wherein the housing comprises a closure arranged at a circumference of the housing, wherein the closure effects in a closed state a gas-tight clamping of the first housing part and of the second housing part with the outer filter element and the inner filter element.

34. A use of an outer filter element and/or of an inner filter element in a gas filter system according to claim 18.
